(19) United States
(12) Patent Application Publication
(10) Pub. No.: US 2014/0099504 A1
(43) Pub. Date: Apr. 10, 2014

(54) PRESSURE-SENSITIVE ADHESIVE FILM

(71) Applicants: Mariko Yoshida, Ibaraki-shi (JP); Natsuki Ukei, Ibaraki-shi (JP); Ikkou Hanaki, Ibaraki-shi (JP)

(72) Inventors: Mariko Yoshida, Ibaraki-shi (JP); Natsuki Ukei, Ibaraki-shi (JP); Ikkou Hanaki, Ibaraki-shi (JP)

(73) Assignee: NITTO DENKO CORPORATION, Ibaraki-shi, Osaka (JP)

(21) Appl. No.: 14/119,530

(22) PCT Filed: May 11, 2012
(86) PCT No.: PCT/JP2012/062192

§ 371 Date: Nov. 22, 2013

(30) Foreign Application Priority Data
May 23, 2011 (JP) 2011-114811

(51) Int. Cl. C09J 7/02

(52) U.S. Cl. CPC C09J 7/0217
USPC 428/355 AC

(57) ABSTRACT

A pressure-sensitive adhesive film, including a substrate and a pressure-sensitive adhesive layer provided on at least one side of the substrate, wherein the pressure-sensitive adhesive layer contains a (meth)acryl-based polymer, an alkali metal salt, and a crosslinking agent, and the pressure-sensitive adhesive layer contains 2 parts by weight or less of the crosslinking agent based on 100 parts by weight of the (meth)acryl-based polymer, the pressure-sensitive adhesive film having an adhesive strength of 0.5 N/25 mm or more as measured at a tension rate of 0.3 m/minute after it is placed on an adherend of an acrylic panel under conditions of 23° C. and 50% RH for 30 minutes, and uses for the film.

### TECHNICAL FIELD

The invention relates to a pressure-sensitive adhesive film having antistatic properties. The pressure-sensitive adhesive film of the invention is used for plastic products and other products which can easily generate static electricity. In particular, the pressure-sensitive adhesive film of the invention is useful as a surface protective film for protecting the surface of an optical member such as a polarizing plate, a wavelength plate, a retardation plate, an optical compensation film, a reflective sheet, a brightness enhancement film, or a diffusion sheet for use in liquid crystal displays or other applications.

### BACKGROUND ART

The invention relates to a pressure-sensitive adhesive film. More specifically, the invention relates to a pressure-sensitive adhesive film that has good adhesive properties (adhesion) to an adherend such as an optical member, specifically, an adherend having unevenness on its surface (having a non-smooth surface), such as a diffusion sheet, and is prevented from generating a peeling electrification voltage during the peeling off of it.

In general, a surface protective film is bonded to an adherend (an object to be protected) with a pressure-sensitive adhesive layer interposed therebetween so that the adherend can be prevented from being scratched or soiled during the processing or conveyance of the adherend. For example, a surface protective film is used on an optical member such as a diffusion sheet. After bonded to an optical member, such a surface protective film is used to protect the adherend during delivery or to prevent the adherend from being scratched or soiled during the processing or conveyance of the adherend. After playing a series of roles, such a surface protective film becomes no longer needed and is finally peeled off and removed.

A substrate, an adhesive, and a separator constituting a surface protective film are often made of plastic materials. Thus, such a surface protective film has high electric insulation and can generate static electricity through friction or peeling off of the film. The static electricity generated through the peeling off can cause dust or dirt to be deposited on the surface protective film, which can pollute a diffusion sheet or other optical members, can cause a defect such as contamination in the process of bonding, or can damage an electronic circuit or a liquid crystal sealed inside the adherend.

Thus, to prevent the problem, various antistatic treatments are performed on a surface protective film.

To suppress such static electrification, there has been proposed an antistatic method including adding a low-molecular-weight surfactant to an adhesive and transferring the surfactant from the adhesive to an adherend (an object to be protected) (see, for example, Patent Document 1). In such a method, however, the added low-molecular-weight surfactant can easily bleed to the surface of the adhesive, and thus staining on the adherend may occur if the method is applied to a surface protective film. Thus, if an adhesive containing a low-molecular-weight surfactant is used to form a surface protective film for use on an optical member such as a diffusion sheet, the problem of a loss of optical properties can occur.

A surface protective film also has a problem in that after it is bonded to an adherend having unevenness on its surface (or having a non-smooth surface), such as a diffusion sheet, it can peel off from the adherend during delivery or transportation. Thus, a surface protective film is required to have a high adhesive strength.

As mentioned above, there are no conventional techniques that can solve the problems in a well-balanced way. In a technical field where antistatic properties, adhesive properties, and removability are important, it has been a problem to meet requirements for further improving a surface protective film.

### PRIOR ART DOCUMENT

### Patent Document

Patent Document 1: JP-A-09-165460

### SUMMARY OF THE INVENTION

### Problems to be Solved by the Invention

In view of the above circumstances, an object of the invention is to provide a pressure-sensitive adhesive film and a surface protective film, which are prevented from causing static buildup on a non-antistatic adherend such as an optical film when used to protect the surface of the adherend and then peeled off from the adherend, and have good adhesive properties.

### Means for Solving the Problems

As a result of earnest study to achieve the object, the inventors have accomplished the invention based on findings that when a pressure-sensitive adhesive film including a substrate and a pressure-sensitive adhesive layer provided on at least one side of the substrate is designed in such a way that the pressure-sensitive adhesive layer contains a (meth)acryl-based polymer, an alkali metal salt, and a specific amount of a crosslinking agent and in such a way that it has an adhesive strength of a specific value or more, an antistatic pressure-sensitive adhesive film can be obtained which has good adhesive properties, is prevented from causing static buildup on a non-antistatic adherend when peeled off from the adherend, and causes less staining on an adherend.

Specifically, the invention is directed to a pressure-sensitive adhesive film including a substrate and a pressure-sensitive adhesive layer provided on at least one side of the substrate, wherein the pressure-sensitive adhesive layer contains a (meth)acryl-based polymer, an alkali metal salt, and a crosslinking agent, and the pressure-sensitive adhesive layer contains 2 parts by weight or less of the crosslinking agent based on 100 parts by weight of the (meth)acryl-based polymer, the pressure-sensitive adhesive film having an adhesive strength of 0.5 N/25 mm or more as measured at a tension rate of 0.3 m/minute after it is placed on an adherend of an acrylic panel under the conditions of 23° C. and 50% RH for 30 minutes. As used herein, the term “(meth)acryl-based polymer” refers to an acryl-based polymer and/or a methacryl-based polymer, and the term “(meth)acrylate” refers to acrylate and/or methacrylate.

The pressure-sensitive adhesive film of the invention preferably has an absolute value of peeling electrification voltage of 0.5 kV or less as measured under the conditions of 23° C. and 50% RH after it is peeled off from an adherend of an acrylic panel at a peeling rate of 10 m/minute.

In the pressure-sensitive adhesive film of the invention, the alkali metal salt is preferably a lithium salt.

In the pressure-sensitive adhesive film of the invention, the pressure-sensitive adhesive layer preferably contains a polyether polyol compound.

The pressure-sensitive adhesive film of the invention is preferably a protective film for use on an optical member.

The pressure-sensitive adhesive film of the invention is preferably a protective film for use on a diffusion sheet.

### Effect of the Invention

The pressure-sensitive adhesive film of the invention has good adhesive properties and is prevented from causing static buildup on a non-antistatic adherend when peeled off from the adherend. In particular, the pressure-sensitive adhesive film of the invention has good adhesive properties (adhesion) to an optical member (adherend) having unevenness on its surface (or having a non-smooth surface), such as a diffusion sheet, and is prevented from generating a peeling electrification voltage during the peeling off of it. In a technical field related to optical and electronic components, where static electricity buildup is a serious problem, an antistatic pressure-sensitive adhesive film or an antistatic surface protective film can be obtained according to the invention, which is very useful.

### MODE FOR CARRYING OUT THE INVENTION

Hereinafter, embodiments of the invention will be described in detail.

The pressure-sensitive adhesive film of the invention includes a substrate and a pressure-sensitive adhesive layer provided on at least one side of the substrate, wherein the pressure-sensitive adhesive layer contains a (meth)acryl-based polymer, an alkali metal salt, and a crosslinking agent, and the pressure-sensitive adhesive layer contains 2 parts by weight or less of the crosslinking agent based on 100 parts by weight of the (meth)acryl-based polymer. The pressure-sensitive adhesive film of the invention has an adhesive strength of 0.5 N/25 mm or more as measured at a tension rate of 0.3 m/minute after it is placed on an adherend of an acrylic panel under the conditions of 23° C. and 50% RH for 30 minutes.

In the invention, the pressure-sensitive adhesive layer contains a (meth)acryl-based polymer. The (meth)acryl-based polymer preferably contains a (meth)acrylic monomer unit having an alkyl group of 1 to 14 carbon atoms. The use of the (meth)acryl-based polymer is preferred in view of easy handleability, adhesive strength, and removability.

In the invention, a (meth)acrylic monomer having an alkyl group of 1 to 14 carbon atoms may be used. Such a (meth)acrylic monomer more preferably has an alkyl group of 4 to 14 carbon atoms. For example, such a (meth)acrylic monomer may be methyl (meth)acrylate or ethyl (meth)acrylate. In particular, preferably used are n-butyl (meth)acrylate, tert-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, etc. These acrylic monomers may be used alone or in combination of two or more.

The content of the (meth)acrylic monomer having an alkyl group of 1 to 14 carbon atoms in the monomers is preferably 50% by weight or more, more preferably 60 to 100% by weight, even more preferably 70 to 98% by weight. Within the range, good interaction with the alkali metal salt and good adhesive properties (adhesion) can be achieved by appropriate control, which is preferred.

Additional polymerizable monomers other than the (meth)acrylic monomer having an alkyl group of 1 to 14 carbon atoms, such as polymerizable monomers for controlling the glass transition point or peeling property of the (meth)acryl-based polymer, may also be used without affecting the effect of the invention. Such other monomers may be used alone or in any combination. The content of such other monomers is preferably less than 50% by weight based on the weight of the monomers (in total).

Examples of such other polymerizable monomers that may be used as needed include cohesive strength or heat resistance improving monomers such as sulfonate group-containing monomers, phosphate group-containing monomers, cyano group-containing monomers, vinyl ester monomers, and aromatic vinyl monomers; and monomers having a functional group capable of improving adhesive strength (adhering strength) or serving as a crosslinking base point, such as carboxyl group-containing monomers, acid anhydride group-containing monomers, amide group-containing monomers, amino group-containing monomers, epoxy group-containing monomers, N-acryloylmorpholine, and vinyl ether monomers. These monomer compounds may be used alone or in combination of two or more.

When an acrylate and/or methacrylate having an acid functional group such as a carboxyl group, a sulfonate group, or a phosphate group is used as a monomer to form the (meth)acryl-based polymer, the content of such an acrylate or methacrylate is preferably adjusted in such a way that the (meth)acryl-based polymer can have an acid value of 40 or less, more preferably 29 or less, even more preferably 16 or less, still more preferably 8 or less, most preferably 1 or less. If the (meth)acryl-based polymer has an acid value of more than 40, undesirable charging characteristics may be provided, which is not preferred.

In the invention, the acid value of the (meth)acryl-based polymer refers to the mg amount of potassium hydroxide required to neutralize the free fatty acids, resin acids, and other acids contained in 1 g of a sample. It is conceivable that the skeleton of the (meth)acryl-based polymer having a large acid value has a large number of carboxyl groups, sulfonate groups, or other acid groups, which can significantly interact with the alkali metal salt, and thus can interfere with the ionic conduction caused by the alkali metal salt, which can make it impossible to obtain high antistatic performance.

For example, 2-ethylhexyl acrylate and acrylic acid may be copolymerized to form an acryl-based polymer having a carboxyl group, as an example of the (meth)acryl-based polymer with an acid value of 40 or less. In this case, such an acid value means that the amount of acrylic acid should be 5.1 parts by weight or less based on 100 parts by weight of the sum of 2-ethylhexyl acrylate and acrylic acid. The acid value can also be adjusted to 29 or less by adjusting the amount of acrylic acid to 3.7 parts by weight or less.

Examples of the sulfonic acid group-containing monomer include styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the phosphoric acid group-containing monomer include 2-hydroxyethylacryloyl phosphate.

Examples of the cyano group-containing monomer include acrylonitrile.

Examples of vinylesters include vinyl acetate, vinyl propionate, and vinyl laurate.

Examples of the aromatic vinyl compound include styrene, chlorostyrene, chloromethylstyrene, α-methylstyrene.

Examples of the carboxyl group-containing monomer include (meth)acrylic acid, carboxyethyl (meth)acrylate, carboxypentyl (meth)acrylate, itaconic acid, maleic acid, fumaric acid, and crotonic acid.

Examples of the acid anhydride group-containing monomer include maleic acid anhydride, and itaconic acid anhydride.

Examples of the hydroxyl group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, and diethylene glycol monovinyl ether, etc. Using the hydroxyl group-containing monomer makes it easy to control the crosslinking and other reactions of a pressure-sensitive adhesive composition as a raw material for the pressure-sensitive adhesive layer and thus makes it easy to control the balance between the improvement of wettability based on fluidization and the reduction of the adhesive strength (adhering strength) during peeling. The hydroxyl group-containing monomer is also advantageously used for antistatic properties because the hydroxyl group can moderately interact with an alkali metal salt and a polyether polyol compound in contrast to a carboxyl or sulfonate group which can generally act as a crosslinking site.

Examples of the amido group-containing monomer include acrylamide, and diethylacrylamide.

Examples of the amino group-containing monomer include N,N-dimethylaminoethyl (meth)acrylate, and N,N-dimethylaminopropyl(meth)acrylate.

Examples of the epoxy group-containing monomer include glycidyl (meth)acrylate, and allyl glycidyl ether.

Examples of vinyl ethers include methyl vinyl ether, ethyl vinyl ether, and isobutyl vinyl ether.

The (meth)acryl-based polymer used in the invention preferably has a weight average molecular weight of 100,000 to 5,000,000, more preferably 200,000 to 4,000,000, even more preferably 300,000 to 3,000,000. If the weight average molecular weight is less than 100,000, the wettability to an adherend may be higher so that the adhesive strength (adhering strength) during peel off may be higher, which may cause damage to the adherend during the peeling process (removal) or tend to cause adhesive residue due to a decrease in the cohesive strength of the pressure-sensitive adhesive layer. On the other hand, if the weight average molecular weight is more than 5,000,000, the polymer may have lower fluidity and thus insufficient wettability to an adherend, which may tend to cause an air bubble between the adherend and the pressure-sensitive adhesive layer of the adhesive (surface protecting) film. The weight average molecular weight refers to a measurement obtained by gel permeation chromatography (GPC).

The (meth)acryl-based polymer preferably has a glass transition temperature (Tg) of 0° C. or lower (generally −100° C. or higher), more preferably −10° C. or lower, even more preferably −20° C. or lower, because with such a glass transition temperature, well-balanced adhesive performance can be easily achieved. If the glass transition temperature is higher than 0° C., the polymer can be less fluid and have insufficient wettability to an adherend, which may tend to cause an air bubble between the adherend and the pressure-sensitive adhesive layer of the adhesive (surface protecting) film. The glass transition temperature (Tg) of the (meth)acryl-based polymer can be adjusted within the range by appropriately changing the component and composition ratio of the monomers.

The production of the (meth)acryl-based polymer is not particularly limited, but for example, a known polymerization method including solution polymerization, emulsion polymerization, bulk polymerization, and suspension polymerization. The solution polymerization is more preferred in view of the workability. The resultant polymer may be any one selected from a random copolymer, a block copolymer and others.

In the invention, the pressure-sensitive adhesive layer contains an alkali metal salt. Compatibility and well-balanced interaction with the (meth)acryl-based polymer and other materials can be obtained using the alkali metal salt, which makes it possible to obtain a pressure-sensitive adhesive film (surface protective film) that can be prevented from causing static buildup on a non-antistatic adherend when peeled off from the adherend.

Examples of an alkali metal salt used in the present invention include a metal salt comprising lithium, sodium, or potassium, and, specifically, a metal salt composed of cations of Li⁺, Na⁺ and K⁺, and anions of Cl⁻, Br⁻, I⁻, AlCl₄⁻, Al₂Cl₇⁻, BF₄⁻. PF₆⁻, ClO₄⁻, NO₃⁻, CH₃COO⁻, CF₃COO⁻, CH₃SO₃⁻, CnF₂ₙ₊₁SO₃⁻ (n is integer), (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, (C₂F₅SO₂)₂N⁻, C₃F₇COO⁻, (CF₃SO₂)(CF₃CO)N⁻, C₉H₁₉COO⁻, (CH₃)₂PO₄⁻, (C₂H₅)₂PO₄⁻, C₂H₅OSO₃⁻, C₆H₁₃OSO₃⁻, C₈H₁₇OSO₃⁻, CH₃(OC₂H₄)₂OSO₃⁻, C₆H₄(CH₃) SO₃⁻, (C₂F₅)₃PF₃⁻, CH₃CH(OH)COO⁻ and (FSO₂)₂N⁻.

It is also possible to use, as an anion component, an anion represented by the following formula (A).

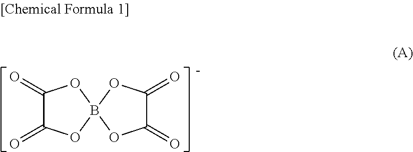

The content of the alkali metal salt is preferably from 0.01 to 3 parts by weight, more preferably from 0.01 to 2 parts by weight, particularly preferably from 0.02 to 1 part by weight, based on 100 parts by weight of the (meth)acryl-based polymer. If the content is less than 0.01 parts by weight, sufficient antistatic properties may fail to be obtained, and if the content is more than 3 parts by weight, staining on an adherend may tend to increase, which is not preferred.

In the invention, the pressure-sensitive adhesive layer also preferably contains a polyether polyol compound. Compatibility and well-balanced interaction with the alkali metal salt, the (meth)acryl-based polymer and other materials can be obtained using the polyether polyol compound, which makes it possible to obtain a pressure-sensitive adhesive film (surface protective film) that causes less staining on an adherend and can be prevented from causing static buildup on a non-antistatic adherend when peeled off from the adherend.

The polyether polyol compound is not particularly limited as long as the compound is ether group-containing polymer polyol, examples of which include polyethylene glycol, polypropylene glycol (diol type), polypropylene glycol (triol type), polytetramethylene ether glycol, and derivatives thereof, and random or block copolymers of polyethylene glycol and polypropylene glycol, such as polypropylene glycol-polyethylene glycol-polypropylene glycol block copolymers, polypropylene glycol-polyethylene glycol block copolymers, polyethylene glycol-polypropylene glycol-polyethylene glycol block copolymers, or polypropylene glycol-polyethylene glycol random copolymers. These compounds may be used alone or in combination of two or more.

The polyether polyol compound preferably has a number average molecular weight of 10,000 or less, more preferably 200 to 5,000. If its number average molecular weight is more than 10,000, it may tend to increase staining. The number average molecular weight refers to a value determined by gel permeation chromatography (GPC).

The content of the polyether polyol compound is preferably from 0.1 to 3 parts by weight, more preferably from 0.2 to 2.5 parts by weight, even more preferably from 0.3 to 2 parts by weight, based on 100 parts by weight of the (meth)acryl-based polymer. If the content is less than 0.1 parts by weight, it may be difficult to obtain sufficient antistatic properties, and if the content is more than 3 parts by weight, staining on an adherend may tend to increase, or adhesive properties may tend to degrade, which is not preferred.

In the invention, the pressure-sensitive adhesive layer contains a crosslinking agent. Selection of the structural units and the component ratio for the (meth)acryl-based polymer, selection of the crosslinking agent, appropriate control of the addition ratio of the crosslinking agent, and crosslinking make it possible to obtain a pressure-sensitive adhesive film (surface protective film) with better heat resistance.

The crosslinking agent used in the invention may be any of an isocyanate compound, an epoxy compound, a melamine resin, an aziridine derivative, a metal chelate compound, and other compounds. In particular, an isocyanate compound or an epoxy compound is preferably used mainly in terms of obtaining an adequate level of cohesive strength. These compounds may be used alone or in combination of two or more.

Examples of isocyanate compounds include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic isocyanates such as 2,4-tolylene diisocyanate, 4,4′-diphenylmethane diisocyanate, and xylylene diisocyanate; and isocyanate adducts such as a trimethylolpropane-tolylene diisocyanate trimer adduct (CORONATE L (trade name) manufactured by NIPPON POLYURETHANE INDUSTRY CO., LTD.), a trimethylolpropane-hexamethylene diisocyanate trimer adduct (CORONATE HL (trade name) manufactured by NIPPON POLYURETHANE INDUSTRY CO., LTD.), and an isocyanurate of hexamethylene diisocyanate (CORONATE HX (trade name) manufactured by NIPPON POLYURETHANE INDUSTRY CO., LTD.). These compounds may be used alone or in combination of two or more.

Among the aforementioned isocyanate compounds, from a viewpoint of control of balance between an adhesive strength and peeling electrification voltage property, preferable examples include a modified isocyanurate of isocyanate (trade named: CORONATE HX, manufactured by Nippon Polyurethane Industry Co., Ltd.), and a modified isocyanurate of isocyante in which tolylene diisocyanate is isocyanate-modified (trade name CORONATE 2030, manufactured by Nippon Polyurethane Industry Co., Ltd.).

Examples of the epoxy compound include N,N,N′,N′-tetraglycidyl-m-xylenediamine (trade name TETRAD-X manufactured by Mitsubishi Gas Chemical Company, Inc.) and 1,3-bis(N,N-diglycidylaminomethyl)cyclohexane (trade name TETRAD-C manufactured by Mitsubishi Gas Chemical Company Inc.). These compounds may be used alone, or may be used by mixing two or more kinds.

Examples of the melamine-based resin include hexamethylolmelamine. Examples of the aziridine derivative include trade name HDU (manufactured by Sogo Pharmaceutical Co., Ltd.), trade name TAZM (manufactured by Sogo Pharmaceutical Co., Ltd.), and trade name TAZO (manufactured by Sogo Pharmaceutical Co., Ltd.) as a commercially available product. These compounds may be used alone, or may be used by mixing two or more kinds.

Metal chelate compounds include a metal component such as aluminum, iron, tin, titanium, or nickel, and a chelate component such as acetylene, methyl acetoacetate, ethyl lactate, or acetylacetone. These compounds may be used alone or in a mixture of two or more.

In an embodiment of the present invention, a polyfunctional monomer having two or more radiation-reactive unsaturated bonds may be added as a crosslinking agent to the pressure-sensitive adhesive composition. In this case, a raw material (the pressure-sensitive adhesive composition) for the pressure-sensitive adhesive layer may be crosslinked by application of radiations. A single molecule of the polyfunctional monomer may have two or more radiation-reactive unsaturated bonds derived from one or more radiation-crosslinkable (curable) moieties such as vinyl, acryloyl, methacryloyl, and vinylbenzyl groups. The polyfunctional monomer that may be preferably used generally has 10 or less radiation-reactive unsaturated bonds. These compounds may be used alone or in a mixture of two or more.

Examples of the polyfunctinal monomer include ethylene glycol di(meth)acrylate, diethlene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinylbenzene, and N,N′-methylenebisacrylamide.

The content of the crosslinking agent used in the invention is 2 parts by weight or less, preferably from 0.05 to 1.5 parts by weight, more preferably from 0.1 to 1 part by weight, based on 100 parts by weight of the (meth)acryl-based polymer. If the content is less than 0.05 parts by weight, the crosslinking agent may insufficiently form a crosslink, so that the cohesive strength of the pressure-sensitive adhesive layer (pressure-sensitive adhesive composition) may low, which may make it impossible to obtain sufficient heat resistance or tend to cause adhesive residue. On the other hand, if the content is more than 2 parts by weight, the polymer may have higher cohesive strength and lower fluidity, so that the wettability on an adherend having unevenness may be insufficient, which may cause insufficient adhesion or lifting at edges.

Examples of radiation include ultraviolet ray, laser ray, α ray, β ray, γ ray, X-ray, and electron beam. From a viewpoint of controlling property and better handling property and a cost, ultraviolet ray is suitably used. More preferably, ultraviolet ray having a wavelength of 200 to 400 nm is used. Ultraviolet ray can be irradiated using an appropriate light source such as a high pressure mercury lamp, a micro-wave excitation-type lamp, and a chemical lamp. When ultraviolet ray is used as irradiation, a photopolymerization initiator is added to an acryl pressure-sensitive adhesive layer.

The photopolymerization initiator depends on a kind of a radiation-reactive component, and may be a substance which produces a radical or a cation by irradiating ultraviolet ray having an appropriately wavelength which can trigger the polymerization reaction.

Example of the photoradical polymerization initiator include benzoins such as benzoin, benzoin methyl ether, benzoin ethyl ether, methyl o-benzoylbenzoate-p-benzoin ethyl ether, benzoin isopropyl ether, and α-methylbenzoin, acetophenes such as benzylmethylketal, trichloroacetophenone, 2,2-diethoxyacetophenone, and 1-hydroxycyclohexyl phenyl ketone, propiophenones such as 2-hydroxy-2-methylpropiophenone, and 2-hydroxy-4′-isopropyl-2-methylpropiophenone, benzophenones such as benzophenone, methylbenzophenone, p-chlorobenzophenone, and p-dimethylaminobenzophenone, thioxanthons such as 2-chlorothioxanthon, 2-ethylthioxanthon, and 2-isopropylthioxanthon, acylphosphine oxides such as bis(2,4,6-trimethylbenzoyl)-phenylphosphine oxide, 2,4,6-trimethylbenzoyldiphenylphosphine oxide, and (2,4,6-trimethylbenzoyl)-(ethoxy)-phenylphosphine oxide, benzil, dibenzsuberone, and α-acyloxime ether. These compounds may be used alone or in a mixture of two or more.

Examples of a photocation polymerization initiator include onium salts such as an aromatic diazonium salt, an aromatic iodonium salt, and an aromatic sulfonium salt, organometallic complexes such as an ion-allene complex. a titanocene complex, and an aryl silanol-aluminum complex, nitrobenzyl ester, sulfonic acid derivative, phosphoric acid ester, phenolsulfonic acid ester, diazonaphthoquinone, and N-hydroxymidosulfonate. These compounds may be used alone or in a mixture of two or more. It is preferably that the photopolymerization initiator is blended usually in a range of 0.1 to 10 parts by weight, preferably 0.2 to 7 parts by weight relative to 100 parts by weight of a (meth)acryl-based polymer.

Further, it is also possible to use a photoinitiation polymerization assistant such as amines. Examples of the photoinitiation assistant include 2-dimethylaminoethyl benzoate, diemethylaminoacetophenone, p-dimethylaminobenzoic acid ethyl ester, and p-dimethylaminobenzoic acid isoamyl ester. These compounds may be used alone or in a mixture of two or more.

It is preferably that the polymerization initiation assistant is blended at 0.05 to 10 parts by weight, further 0.1 to 7 parts by weight relative to 100 parts by weight a (meth)acryl-based polymer.

In the invention, the pressure-sensitive adhesive layer (pressure-sensitive adhesive composition) may contain any other additive. Examples of such an additive that may be used as needed include a crosslinking catalyst, a crosslinking retarder, a filler, a colorant, a pigment, a surfactant, a plasticizer, a tackifier, a low-molecular-weight polymer, etc.

The pressure-sensitive adhesive film of the invention can be obtained by forming the pressure-sensitive adhesive layer on a substrate (support). In this process, the pressure-sensitive adhesive composition as a raw material for the pressure-sensitive adhesive layer is generally crosslinked after the composition is applied. Alternatively, however, after crosslinked, the pressure-sensitive adhesive layer may be transferred onto the substrate (support) or the like.

When a photopolymerization initiator as an optional component is added as mentioned above, the pressure-sensitive adhesive composition (solution) may be applied directly onto an adherend or applied to one or both sides of a substrate (support or supporting substrate) and then irradiated with light so that a pressure-sensitive adhesive layer can be obtained. In general, the pressure-sensitive adhesive composition is photo-polymerized by irradiation with ultraviolet light with a wavelength of 300 to 400 nm and an irradiance of 1 to 200 mW/cm² at a dose of about 400 to about 4,000 mJ/cm², so that the pressure-sensitive adhesive film is obtained.

The pressure-sensitive adhesive layer may be formed on the substrate (support) using any method. For example, the pressure-sensitive adhesive layer is formed on the substrate by a process including applying the pressure-sensitive adhesive composition (solution) to the substrate and removing the polymerization solvent and so on by drying. Subsequently, curing may be performed to control the migration of the components in the pressure-sensitive adhesive layer or to control the crosslinking reaction. When the pressure-sensitive adhesive composition is applied to the substrate to form a pressure-sensitive adhesive film, one or more solvents other than the polymerization solvent may be newly added to the composition so that the composition can be uniformly applied to the substrate.

In addition, as a method of forming the pressure-sensitive adhesive layer of the present invention, the known method used for preparing pressure-sensitive adhesive sheets is used. Specifically, examples include roll coating, gravure coating, reverse coating, roll brushing, spray coating, and air knife coating methods.

Further, the previously known tackifiers, or the previously known various additives such as a tackifier, a surface lubricant agent, a leveling agent, an antioxidant, a corrosion preventing agent, a photo stabilizer, an ultraviolet absorbing agent, a polymerization inhibitor, a silane coupling agent, and a powder, a particle, and a foil of inorganic or organic filer, metal powder and pigment may be appropriately added to the pressure-sensitive adhesive composition used in the pressure-sensitive adhesive film of the present invention depending on utility.

The aforementioned pressure-sensitive adhesive layer is coated on one side or both sides of various substrates (supports) comprising a plastic film such as a polyester film, or a porous material such as a paper and a non-woven fabric at a thickness of usually 3 to 100 mm, preferably around 5 to 50 μm, to form an aspect of a sheet or a tape.

A substrate constituting a pressure-sensitive adhesive film (surface protecting film) is preferably a resin film having heat resistance and solvent resistance and, at the same time, having flexibility. By the substrate having flexibility, a pressure-sensitive adhesive composition (solution) can be coated by a roll coater etc., and can be wound in a roll-like.

Examples of a resin forming the substrate include polyethylene terephthalate, polyester, polyethylene, polypropylene, polystyrene, polyimide, polyvinyl alcohol, polyvinyl chloride, fluorine-containing resin such as polyfluoroethylene, nylon, and cellulose.

In addition, in order to improve adhesion between a pressure-sensitive adhesive layer and a substrate, a surface of a substrate may be corona-treated. Alternatively, the backside of a substrate may be surface-treated.

In the present invention, as a substrate (support), a plastic substrate is suitably used. A plastic substrate is not particularly limited as far as it can be formed into a sheet shape or a film-shape, and examples include polyolefin films such as polyethylene, polypropylene, poly-1-butene, poly-4-methyl-1-pentene, ethylene.propylene copolymer, ethylene.1-butene copolymer, ethylene.vinyl acetate copolymer, ethylene.ethyl acrylate copolymer, and ethylene.vinyl alcohol copolymer, polyester films such as polyethylene terephthalate, polyethylene naphthalate, and polybutylene terephthalate, polyacrylate films, polystyrene films, polyamide films such as nylon 6, nylon 6,6, and partially aromatic polyamide, polyvinyl chloride films, polyvinylidene chloride films, and polycarbonate films.

The substrate generally has a thickness of about 5 to about 200 μm, preferably about 10 to about 100 μm. The surface of the substrate to be bonded to the pressure-sensitive adhesive layer may be subjected, as needed, to a treatment with a release agent such as a silicone, fluoride, long-chain alkyl, or fatty acid amide release agent, or silica powder.

One side of the substrate may be subjected to releasing, or anti-staining treatment with silicone, fluorine, long chain alkyl-based or fatty acid amide-based releasing agent, or a silica powder, easy adhesion treatment such as acid treatment, alkali treatment, primer treatment, corona treatment, plasma treatment, and ultraviolet ray treatment.

The substrate to be used preferably has undergone an antistatic treatment. Such an antistatic treatment may be performed on a plastic substrate using, as a non-limiting example, a method of providing an antistatic layer on at least one side of a general-use substrate or a method of kneading a kneading-type antistatic agent into a plastic substrate.

Examples of the method of providing an antistatic layer on at least one side of the substrate include a method of applying an antistatic resin composed of the antistatic agent described below and a resin component or applying a conductive polymer or a conductive material-containing conductive resin; and a method of vapor-depositing or plating a conductive material.

If necessary, the pressure-sensitive adhesive film of the invention may further include a separator that is bonded to the surface of the pressure-sensitive adhesive layer to protect the adhesive surface. A paper sheet or a plastic film may be used as a substrate to form a separator, and a plastic film is preferably used because it has high surface smoothness. Such a film is not particularly limited as long as the film is capable of protecting the pressure-sensitive adhesive layer, and examples of such a film include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film, etc.

The separator (plastic substrate) used in the invention may also have undergone an antistatic treatment. Such an antistatic treatment may be performed on a plastic substrate using, as a non-limiting example, the same method as described above for the substrate.

Examples of the antistatic agent in the antistatic resin used to form the substrate or the separator include cationic antistatic agents such as quaternary ammonium salts, pyridinium salts, and those having a cationic functional group such as a primary, secondary, or tertiary amino group; anionic antistatic agents such as sulfonates, sulfuric ester salts, phosphonates, phosphoric ester salts, and those having an anionic functional group; amphoteric antistatic agents such as alkyl betaine and derivatives thereof, imidazoline and derivatives thereof, and alanine and derivatives thereof; nonionic antistatic agents such as aminoalcohol and derivatives thereof, glycerin and derivatives thereof, and polyethylene glycol and derivatives thereof; and ion-conducting polymers obtained by polymerization or copolymerization of the cationic, anionic, and/or amphoteric monomer having an ion-conducting group. These compounds may be used alone or in combination of two or more.

Specifically, examples of the cation-type electrification preventing agent include a (meth)acrylate copolymer having a quaternary ammonium group such as an alkyl trimethylammonium salt, acyloylamidopropyltrimethylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion-type electrification preventing agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric-type electrification preventing agent include alkylbetain, alkylimidazoliumbetain, and carbobetaingrafted copolymer. These compounds may be used alone, or two or more kinds may be used by mixing.

Examples of the nonion-type electrification preventing agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxyethylene sorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol (meth)acrylate. These compounds may be used alone, or two or more kinds may be used by mixing.

Examples of the electrically conductive polymer include polyaniline, polypyrrole and polythiophene. These electrically conductive polymers may be used alone, or two or more kinds may be used by mixing.

Examples of the electrically conductive substance include tin oxide, antimony oxide, indium oxide, cadmium oxide, titanium oxide, zinc oxide, indium, tin, antimony, gold, silver, copper, aluminum, nickel, chromium, titanium, iron, covert, copper iodide, and an alloy and a mixture thereof.

As a resin component used in the electrification preventing resin and the electrically conductive resin, a generally used resin such as polyester, acryl, polyvinyl, urethane, melanine and epoxy is used. In the case of a polymer-type electrification preventing agent, it is not necessary that a resin component is contained. In addition, the electrification preventing resin component may contain compounds of a methylolated or alkylolated melanine series, a urea series, a glyoxal series, and an acrylamide series, an epoxy compound, or an isocyanate compound as a crosslinking agent.

An electrification preventing layer is formed, for example, by diluting the aforementioned electrification preventing resin, electrically conductive polymer or electrically conductive resin with a solvent such as an organic solvent and water, and coating this coating solution on a plastic substrate, followed by drying.

Examples of an organic solvent used in formation of the electrification preventing layer include methyl ethyl ketone, acetone, ethyl acetate, tetrahydrofuran, dioxane, cyclohexanone, n-hexane, toluene, xylene, methanol, ethanol, n-propanol and isopropanol. These solvents may be used alone, or two or more kinds may be used by mixing.

As a coating method in formation of the electrification preventing layer, the known coating method is appropriately used, and examples include roll coating, gravure coating, reverse coating, roll brushing, spray coating, and air knife coating methods, an immersing and curtain coating method.

A thickness of the aforementioned electrification preventing resin layer, electrically conductive polymer or electrically conductive resin is usually 0.01 to 5 μm, preferably around 0.03 to 1 μm.

Examples of a method of depositing or plating an electrically conductive substance include vacuum deposition, sputtering, ion plating, chemical deposition, spray pyrolysis, chemical plating, and electric plating methods.

The thickness of the electrically-conductive substance layer is generally from 20 to 10000 angstrom (0.002 to 1 μm), preferably from 50 to 5000 angstrom (0.005 to 0.5 μm).

As the kneading-type antistatic agent, the aforementioned antistatic agent is appropriately used. The amount of the kneading-type antistatic agent to be blended is 20% by weight or less, preferably in a range of 0.05 to 10% by weight, based on the total weight of a plastic substrate. A kneading method is not particularly limited as far as it is a method by which the antistatic agent can be uniformly mixed into a resin used in a plastic substrate, but for example, a heating roll, a Banbury mixer, a pressure kneader, and a biaxial kneading machine are used.

The pressure-sensitive adhesive film of the invention is used for plastic products and other products which can easily generate static electricity. In particular, the pressure-sensitive adhesive film of the invention can be used as a surface protective film for protecting the surface of an optical member such as a polarizing plate, a wavelength plate, a retardation plate, an optical compensation film, a reflective sheet, a brightness enhancement film, or a diffusion sheet, which is for use in a display device such as a liquid crystal display or an organic electro-luminescent display, a touch panel produced with such a display device, and other devices.

### EXAMPLES

Hereinafter, the features and effects of the invention will be more specifically described with reference to examples and others, which however are not intended to limit the invention. The evaluation items in the examples and others were measured as described below.

### <Measurement of the Weight Average Molecular Weight of Acryl-Based Polymer>

The weight average molecular weight of the prepared polymer was measured using gel permeation chromatography (GPC).

Analyzer: HLC-8220GPC manufactured by TOSOH CORPORATION

### Columns:

Columns for sample: TSKguardcolumn Super HZ-H (a single column)+TSKgel Super HZM-H (two columns) manufactured by TOSOH CORPORATION
Reference column: TSKgel Super H-RC (a single column) manufactured by TOSOH CORPORATION
Flow rate: 0.6 ml/minute
Injection volume: 10 μl
Column temperature: 40° C.

### Eluent: THF

Injected sample concentration: 0.2% by weight
Detector: differential refractometer

The weight average molecular weight was the polystyrene-equivalent weight average molecular weight determined using polystyrene calibration.

### <Measurement of Glass Transition Temperature(Tg)>

A glass transition temperature Tg (° C.) was determined by the following equation using the following reference values as a glass transition temperature Tgn (° C.) of a homopolymer of each monomer.

1/(Tg+273)=Σ[Wn/(Tgn+273)] Equation

[where Tg (° C.) represents a glass transition temperature of a copolymer, Wn (-) represents a weight fraction of each monomer, Tgn (° C.) represents a glass transition temperature of a homopolymer of each monomer, and n represents a kind of each monomer]
Reference values:

2-ethylhexyl acrylate: −70° C.

isononyl (meth)acrylate: −82° C.

butyl acrylate: −55° C.

ethyl acrylate: −22° C.

2-hydroxyethyl acrylate: −15° C.

acrylic acid: −106° C.

For the literature values, reference was made to “Acryl Jushi no Gosei Sekkei to Shin-Yoto Kaihatsu (Synthesis/Design of Acrylic Resins and Development of New Applications” (published by Chuo Keiei Kaihatsu Center Shuppan-bu)

### <Measurement of Acid Value>

An acid value was measured using an automatically titrating apparatus (COM-550 manufactured by HIRANUMA SANGYO Co., Ltd.), and was obtained by the following equation.

A={(Y−X)×f×5.611}/M

A; Acid value

Y; Titration amount of sample solution (ml)

X; Titration amount of solution of only 50 g of mixed solvent (ml)

f; Factor of titration solution

M; Weight of polymer sample (g)

Measuring conditions are as follows.

Measurement conditions are as follows:

Sample solution: About 0.5 g of a polymer sample was dissolved in 50 g of a mixed solvent (toluene/2-propanol/distilled water=50/49.5/0.5, weight ratio) to obtain a sample solution.

Titration solution: 0.1N 2-propanolic potassium hydroxide solution (for petroleum product neutralization value test manufactured by Wako Pure Chemical Industries, Ltd.)

Electrode: glass electrode; GE-101, comparative electrode; RE-201, Measurement mode: petroleum product neutralization value test 1

### <Measurement of Adhesive Strength>

The pressure-sensitive adhesive film was cut into a piece with a size of 25 mm in width and 100 mm in length, and the cut piece was laminated to an acrylic panel (ACRYLITE manufactured by Mitsubishi Rayon Co., Ltd.) under the pressure bonding conditions of 0.25 MPa and a rate of 0.3 m/minute, so that an evaluation sample was obtained. After the lamination, the sample was allowed to stand for 30 minutes and then measured for adhesive strength with a universal tensile tester while the piece was peeled off at a peeling angle of 180° and a peeling rate of 0.3 m/minute. The measurement was performed in an environment at 23° C. and 50% RH.

The pressure-sensitive adhesive film of the invention has an adhesive strength of 0.5 N/25 mm or more, preferably 0.6 to 6 N/25 mm, more preferably 0.6 to 4 N/25 mm. Within the range, the pressure-sensitive adhesive film can have sufficient adhesive properties even to an adherend having unevenness on its surface (having a non-smooth surface), such as a diffusion sheet.

### <Measurement of Peeling Electrification Voltage>

The pressure-sensitive adhesive film was cut into a piece with a size of 70 mm in width and 130 mm in length, and the separator was peeled off. Using a hand roller, the piece was then pressure-bonded to the surface of a 1 mm thick, 70 mm wide, 100 mm long acrylic panel (ACRYLITE manufactured by Mitsubishi Rayon Co., Ltd.), which had undergone static elimination in advance, in such a way that one end of the piece protruded 30 mm out of the panel. The resulting sample was allowed to stand in an environment at 23° C. and 50% RH for a day and then set at a predetermined location as shown below. The one end protruding 30 mm was fixed to an automatic winder, and the piece was peeled off at a peeling angle of 150° and a peeling rate of 10 m/minute. The removed pressure-sensitive adhesive film was placed on a sample mount, and the potential on the surface of the adhesive was measured using an electrostatic voltmeter (KSD-0103 manufactured by KASUGA ELECTRIC WORKS LTD.) fixed at a predetermined position. The measurement was performed in an environment at 23° C. and 50% RH.

The pressure-sensitive adhesive film of the invention preferably has an absolute value of peeling electrification voltage of 0.5 kV or less, more preferably 0.4 kV or less, particularly preferably 0.3 kV or less. Within the range, the pressure-sensitive adhesive film has good antistatic properties.

### <Preparation of (Meth)Acryl-Based Polymer>

### [Acryl-Based Polymer (A)]

A four-neck flask equipped with a stirring blade, a thermometer, a nitrogen gas introducing tube, a condenser, and a dropping funnel was charged with 200 parts by weight of 2-ethylhexyl acrylate, 8 parts by weight of 2-hydroxyethyl acrylate, 0.4 parts by weight of 2,2′-azobisisobutyronitrile as a polymerization initiator, and 312 parts by weight of ethyl acetate. Nitrogen gas was introduced into the flask while the mixture was gently stirred, and a polymerization reaction was performed for 6 hours while the temperature of the liquid in the flask was kept at about 65° C., so that a solution (40% by weight) of an acryl-based polymer (A) was obtained. The acryl-based polymer (A) had a weight average molecular weight of 500,000, a glass transition temperature (Tg) of −68° C., and an acid value of 0.0.

### <Preparation of Antistatic Agent Solution>

[Antistatic Agent Solution (a)]

A four-neck flask equipped with a stirring blade, a thermometer, a condenser, and a dropping funnel was charged with 20 parts by weight of lithium iodide and 80 parts by weight of ethyl acetate. While the temperature of the liquid in the flask was kept at about 80° C., the materials were mixed by stirring for 2 hours to form an antistatic agent solution (a) (20% by weight).

[Antistatic Agent Solution (b)]

A four-neck flask equipped with a stirring blade, a thermometer, a condenser, and a dropping funnel was charged with 20 parts by weight of lithium perchlorate and 80 parts by weight of ethyl acetate. While the temperature of the liquid in the flask was kept at about 80° C., the materials were mixed by stirring for 2 hours to form an antistatic agent solution (b) (20% by weight).

[Antistatic Agent Solution (c)]

A four-neck flask equipped with a stirring blade, a thermometer, a condenser, and a dropping funnel was charged with 1 part by weight of LiN(C₂F₅SO₂)₂, 14 parts by weight of a polypropylene glycol-polyethylene glycol-polypropylene glycol block copolymer (PEP, 2,000 in number average molecular weight, 50% by weight in ethylene glycol group content), and 60 parts by weight of ethyl acetate. While the temperature of the liquid in the flask was kept at about 80° C., the materials were mixed by stirring for 2 hours to form an antistatic agent solution (c) (20% by weight).

[Antistatic Agent Solution (d)]

A four-neck flask equipped with a stirring blade, a thermometer, a condenser, and a dropping funnel was charged with 2 parts by weight of LiN(C₂F₅SO₂)₂, 18 parts by weight of polypropylene glycol (PPG, diol type, 2,000 in number average molecular weight, 0% by weight in ethylene glycol group content), and 80 parts by weight of ethyl acetate. While the temperature of the liquid in the flask was kept at about 80° C., the materials were mixed by stirring for 2 hours to form an antistatic agent solution (d) (20% by weight).

[Antistatic Agent Solution (e)]

A four-neck flask equipped with a stirring blade, a thermometer, a condenser, and a dropping funnel was charged with 0.5 parts by weight of LiN(C₂F₅SO₂)₂, 35 parts by weight of a polypropylene glycol-polyethylene glycol-polypropylene glycol block copolymer (PEP, 2,000 in number average molecular weight, 50% by weight in ethylene glycol group content), and 142 parts by weight of ethyl acetate. While the temperature of the liquid in the flask was kept at about 80° C., the materials were mixed by stirring for 2 hours to form an antistatic agent solution (e) (20% by weight).

### <Preparation of Antistatic-Treated Polyethylene Terephthalate Film>

An antistatic agent solution was prepared by diluting 10 parts by weight of an antistatic agent (MICRO-SOLVER RMd-142 manufactured by SOLVEX INC., composed mainly of tin oxide and polyester resin) with a mixed solvent of 30 parts by weight of water and 70 parts by weight of methanol. The resulting antistatic agent solution was applied to a polyethylene terephthalate (PET) film (38 μm in thickness, substrate) using a Mayer bar. The solvent was removed by drying at 130° C. for 1 minute. As a result, an antistatic layer (0.2 μm in thickness) was formed, and an antistatic-treated PET film was obtained.

### Example 1

### Preparation of Adhesive Solution

To 100 parts by weight (solid basis) of the acryl-based polymer (A) were added 0.5 parts by weight of the antistatic agent (a), 0.5 parts by weight of a trimethylolpropane-tolylene diisocyanate trimer adduct (CORONATE L (C/L) manufactured by Nippon Polyurethane Industry Co., Ltd.) as a crosslinking agent, and 0.03 parts by weight of dibutyltin dilaurate as a crosslinking catalyst, respectively. The mixture was stirred and mixed, and then diluted to 20% by weight with ethyl acetate, so that an acryl-based pressure-sensitive adhesive solution (1) was obtained. As used herein, the term “parts by weight” indicates the weight of the corresponding solid. The same will apply hereinafter.

### [Preparation of Pressure-Sensitive Adhesive Film]

The acryl-based pressure-sensitive adhesive solution (1) was applied to the surface of the antistatic-treated PET film opposite to its antistatic-treated surface, and heated at 110° C. for 3 minutes to form a 20 μm thick adhesive layer. Subsequently, a polyethylene terephthalate (PET) film (25 μm in thickness) with its one side silicone-treated was provided, and the surface of the pressure-sensitive adhesive layer was bonded to the silicone-treated side of the polyethylene terephthalate film, so that a pressure-sensitive adhesive film was obtained. The silicone-treated PET film was peeled off when the pressure-sensitive adhesive film was used.

### Example 2

A pressure-sensitive adhesive film was prepared using the same process as in Example 1, except that 1.0 part by weight of the antistatic agent (b) was used instead of the antistatic agent (a) in the preparation of the adhesive of Example 1.

### Example 3

A pressure-sensitive adhesive film was prepared using the same process as in Example 1, except that 0.5 parts by weight of the antistatic agent (c) was used instead of the antistatic agent (a) in the preparation of the adhesive of Example 1.

### Example 4

A pressure-sensitive adhesive film was prepared using the same process as in Example 1, except that 0.75 parts by weight of the antistatic agent (c) was used instead of the antistatic agent solution (a) in the preparation of the adhesive of Example 1.

### Example 5

A pressure-sensitive adhesive film was prepared using the same process as in Example 1, except that 1.0 part by weight of the antistatic agent (d) was used instead of the antistatic agent solution (a) in the preparation of the adhesive of Example 1.

### Example 6

A pressure-sensitive adhesive film was prepared using the same process as in Example 1, except that 1.5 parts by weight of the antistatic agent (c) was used instead of the antistatic agent (a) and 0.2 parts by weight of an isocyanurate of hexamethylene diisocyanate (CORONATE HX (C/HX) manufactured by Nippon Polyurethane Industry Co., Ltd.) was used as a crosslinking agent instead of the trimethylolpropane-tolylene diisocyanate trimer adduct (CORONATE L (C/L) manufactured by Nippon Polyurethane Industry Co., Ltd.) in the preparation of the adhesive of Example 1.

### Comparative Example 1

A pressure-sensitive adhesive film was prepared using the same process as in Example 1, except that the antistatic agent solution (a) was not used in the preparation of the adhesive of Example 1.

### Comparative Example 2

A pressure-sensitive adhesive film was prepared using the same process as in Example 1, except that the antistatic agent (a) was used in an amount of 0.7 parts by weight and the trimethylolpropane-tolylene diisocyanate trimer adduct (CORONATE L (C/L) manufactured by Nippon Polyurethane Industry Co., Ltd.) was used in an amount of 2.5 parts by weight as a crosslinking agent in the preparation of the adhesive of Example 1.

### Comparative Example 3

A pressure-sensitive adhesive film was prepared using the same process as in Example 1, except that 3.55 parts by weight of the antistatic agent (e) was used instead of the antistatic agent (a) in the preparation of the adhesive of Example 1.

The prepared pressure-sensitive adhesive films were measured for peeling electrification voltage and adhesive strength according to the methods described above. Table 1 shows the results. All values in units of parts by weight each indicate the solid content based on 100 parts by weight of the polymer.

TABLE 1

| Formulation (solid content | | | | | | | | Comparative | | |
|---|---|---|---|---|---|---|---|---|---|---|
| (parts by weight)) and | | Example | | | | | | Example | | |
| evaluation results | | 1 | 2 | 3 | 4 | 5 | 6 | 1 | 2 | 3 |
| Antistatic agent | | (a) | (b) | (c) | (c) | (d) | (c) | — | (a) | (e) |
| Alkali metal | Type | LiI | LiClO₄ | LiN(C₂F₅SO₂)₂ | LiN(C₂F₅SO₂)₂ | LiN(C₂F₅SO₂)₂ | LiN(C₂F₅SO₂)₂ | — | LiI | LiN (C₂F₅SO₂)₂ |
| salt | Content | 0.50 | 1.00 | 0.03 | 0.05 | 0.10 | 0.10 | — | 0.70 | 0.05 |
| Polyether | Type | — | — | PEP | PEP | PPG | PEP | — | — | PEP |
| polyol | Content | — | — | 0.47 | 0.70 | 0.90 | 1.40 | — | — | 3.50 |
| compound | | | | | | | | | | |
| Crosslinking | Type | C/L | C/L | C/L | C/L | C/L | C/HX | C/L | C/L | C/L |
| agent | Content | 0.5 | 0.5 | 0.5 | 0.5 | 0.5 | 0.2 | 0.5 | 2.5 | 0.5 |
| Adhesive | N/25 mm | 2.7 | 2.6 | 1.0 | 0.7 | 0.6 | 0.6 | 2.8 | 0.1 | 0.2 |
| strength | | | | | | | | | | |
| Peeling | kV | 0.0 | 0.0 | 0.0 | 0.0 | 0.2 | 0.0 | 3.3 | 0.0 | 0.0 |
| electrification | (absolute | | | | | | | | | |
| voltage | value) | | | | | | | | | |

From the results in Table 1, it is apparent that in all of Examples 1 to 6, peeling electrification voltage is suppressed and good adhesive strength is provided. In contrast, it is apparent that in Comparative Example 1 where the alkali metal salt is not added, peeling electrification voltage is not suppressed; in Comparative Example 2 where the crosslinking agent is added in a large amount, sufficient adhesive strength is not obtained; in Comparative Example 3 where the polyether polyol compound is added in a large amount, sufficient adhesive strength is also not obtained; and all the films obtained in Comparative Examples 1 to 3 are not suitable as surface protective films for use on optical members such as diffusion sheets.

1. A pressure-sensitive adhesive film, comprising a substrate and a pressure-sensitive adhesive layer provided on at least one side of the substrate, wherein
the pressure-sensitive adhesive layer contains a (meth)acryl-based polymer, an alkali metal salt, and a crosslinking agent, and
the pressure-sensitive adhesive layer contains 2 parts by weight or less of the crosslinking agent based on 100 parts by weight of the (meth)acryl-based polymer,
the pressure-sensitive adhesive film having an adhesive strength of 0.5 N/25 mm or more as measured at a tension rate of 0.3 m/minute after it is placed on an adherend of an acrylic panel under conditions of 23° C. and 50% RH for 30 minutes.

2. The pressure-sensitive adhesive film according to claim 1, which has an absolute value of peeling electrification voltage of 0.5 kV or less as measured under conditions of 23° C. and 50% RH after it is peeled off from an adherend of an acrylic panel at a peeling rate of 10 m/minute.

3. The pressure-sensitive adhesive film according to claim 1, wherein the alkali metal salt is a lithium salt.

4. The pressure-sensitive adhesive film according to claim 1, wherein the pressure-sensitive adhesive layer contains a polyether polyol compound.

5. The pressure-sensitive adhesive film according to claim 1, which is a protective film for use on an optical member.

6. The pressure-sensitive adhesive film according to claim 1, which is a protective film for use on a diffusion sheet.

7. The pressure-sensitive adhesive film according to claim 2, which is a protective film for use on an optical member.

8. The pressure-sensitive adhesive film according to claim 3, which is a protective film for use on an optical member.

9. The pressure-sensitive adhesive film according to claim 4, which is a protective film for use on an optical member.

10. The pressure-sensitive adhesive film according to claim 2, which is a protective film for use on a diffusion sheet.

11. The pressure-sensitive adhesive film according to claim 3, which is a protective film for use on a diffusion sheet.

12. The pressure-sensitive adhesive film according to claim 4, which is a protective film for use on a diffusion sheet.
